(19) United States
(12) Patent Application Publication
(10) Pub. No.: US 2004/0028906 A1
(43) Pub. Date: Feb. 12, 2004

(54) Diamond-like carbon coating on glass and plastic for added hardness and abrasion resistance

(76) Inventors: Jerrel Charles Anderson, Vienna, WV (US); Don M. Coates, Santa Fe, NM (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/373,514

(22) Filed: Feb. 25, 2003

Related U.S. Application Data
(63) Continuation-in-part of application No. 09/747,673, filed on Dec. 22, 2000, now abandoned.
(63) Continuation-in-part of application No. 09/747,674, filed on Dec. 22, 2000, now abandoned.
(60) Provisional application No. 60/174,501, filed on Jan. 4, 2000.

(51) Int. Cl. B32B 9/00

(52) U.S. Cl. 428/408; 428/426

(57) ABSTRACT

The present invention is a non-metallic article that has been coated with a diamond-like carbon (DLC) coating. A coated article of the present invention has increased hardness, increased abrasion resistance, and a reduced coefficient of friction when compared with the same properties of the article prior to the article being coated. DLC coatings of the present invention are applied in a chamber filled with hydrocarbon plasma and with application of electrical pulses.

### BACKGROUND OF THE INVENTION

This application is a Continuation-in-Part of U.S. application Ser. No. 09/747,673 filed on Dec. 22, 2000 which claims the benefit of U.S. Provisional Application Serial No. 60/174,502 filed on Dec. 30, 1999, and U.S. application Ser. No. 09/747,674 filed on Dec. 22, 2000 which claims the benefit of U.S. Provisional Application Serial No. 60/174,501 filed on Dec. 30, 1999.

### FIELD OF THE INVENTION

This invention relates to articles that are coated for increased hardness and abrasion resistance. This invention particularly relates to coatings that increase hardness and abrasion resistance on articles comprised of such materials as glass, ceramic, and/or plastic.

### DESCRIPTION OF THE PRIOR ART

Protective coatings on surfaces that come in contact with other objects can be desirable in applications where the surface can be scratched or abraded by such contact, and where such wear on the surface is undesirable. In addition, hard protective coatings that also have a low coefficient of friction can be desirable in applications where good wear resistance is necessary or desirable. Applying DLC coatings to hard metallic surfaces has been carried out using the plasma source ion implantation (PSII) technique, wherein a potential is applied to an article that is to be coated in order to attract the plasma ions to the surface of the article. U.S. Pat. No. 4,764,394 describes the PSII technique, and how it can be useful for implanting ions beneath the surface of various materials. The PSII method utilizes high voltage of typically greater than 20 kilovolts to drive plasma ions beneath the surface of a target material.

Various methods for applying DLC coatings are known and described: U.S. Pat. No. 4,504,519; U.S. Pat. No. 5,190,824; U.S. Pat. No. 5,827,613; U.S. Pat. No. 4,746,538; U.S. Pat. No. 4,877,677; U.S. Pat. No. 4,728,529; U.S. Pat. No. 6,261,693 B1; U.S. Pat. No. 5,618,619; U.S. Pat. No. 4,698,256; U.S. Pat. No. 4,809,876; U.S. Pat. No. 4,764,394; U.S. Pat. No. 5,470,661; EP 0550630 B1; EP 0821077 A2; and EP 0962550 A1 each describe a process for applying carbon coatings to a substrate.

It is known by those skilled in the art of deposition of diamond-like carbon coatings that conventional chemical vapor deposition (CVD) processes for application of DLC coatings do not provide a smooth compositional transition from the substrate to the DLC coating. That is to say that in other processes such as a CVD process, the DLC coat is applied only to the surface of the substrate, thereby creating a discrete compositional transition from the material that makes up the substrate to the DLC coating. This type of stark transition can be problematic inasmuch as stresses can exist, or be created, between the two dissimilar compositional phases (that is, DLC coat and the substrate material). For example, adhesion between the two dissimilar compositions can be very poor. Particularly when the substrate is a flexible material, the adhesions can be so poor that the DLC coat can simply fall off of the substrate. Also, DLC coatings can typically be very brittle, and when coated onto a substrate which is soft and/or flexible, cracks can arise in the DLC coating, or the coating can fail to adhere to the substrate.

Conventional processes used to apply DLC coatings to a substrate—such as CVD—can utilize adhesive coats that are discrete and distinct adhesive layers that are sandwiched between the DLC coating and the substrate surface. Alternatively a CVD process can require a pre-treatment of the surface of the substrate to be coated in order to increase the adhesion between the DLC coating and the substrate. There, again, is a discrete and distinct film layer positioned between the DLC coat and the substrate surface.

It can be desirable to apply a DLC coating to an object in order to increase surface hardness, increase abrasion resistance, and/or to lower the coefficient of friction on the surface of the article.

It can be desirable to apply a DLC coating onto the surface of a plastic article having an initially soft surface in order to increase the hardness and abrasion resistance of the plastic article.

It can particularly be desirable to apply a DLC coating by a process that will enhance adhesion of the coating to the substrate without the need to apply a discrete or distinct adhesive coating, or pre-treat the surface of the substrate in order to increase adhesion between the substrate and the DLC coating.

### SUMMARY OF THE INVENTION

In one aspect, the present invention is an article comprising a diamond-like carbon (DLC) coating on a non-metallic substrate, wherein the non-metallic substrate is coated in a process comprising the step of applying an electrical pulse having a potential of at least about 0.5 to about 10 kilovolts (kV) to the substrate while the substrate is immersed in a hydrocarbon plasma.

In another aspect, the present invention is an article comprising a diamond-like carbon (DLC) coating on a non-metallic substrate, wherein the non-metallic substrate is coated in a process comprising the step of applying an electrical pulse having a potential of at least about 0.5 to about 10 kilovolts (kV) to the substrate while the substrate is immersed in a hydrocarbon plasma, and wherein the non-metallic substrate is glass.

In still another aspect, the present invention is a process of making a DLC coated non-metallic article, the process comprising the steps of: placing a substrate article on a metallic holder in such a manner that a portion of at least one surface of the substrate can be exposed to a plasma; immersing the article in a plasma; and applying an electrical pulse having a potential of at least about 0.5 to about 10 kilovolts (kV) to the metallic holder such that the plasma particles are deposited onto the exposed surface of the substrate.

In another aspect, the present invention is a plastic article having a coating comprising or consisting essentially of a diamond-like carbon (DLC) coating directly on a surface of the plastic, wherein no adhesive or film layer intervenes between the DLC coat and the surface of the plastic, and wherein the plastic is coated in a process comprising the step of applying an electrical pulse having a potential of at least about 0.5 to about 10 kilovolts (kV) to the plastic while the plastic is immersed in a hydrocarbon plasma.

### DETAILED DESCRIPTION

In one embodiment, the present invention is a nonmetallic article which has been coated with a diamond-like carbon covering. Articles coated in the practice of the present invention are non-metallic articles such as glass, ceramics, plastics, and laminated articles. A DLC coated article of the present invention has increased hardness, increased abrasion or scratch resistance, and a lower coefficient of friction on the surface of the coated article than the non-coated article.

A DLC coated article of the present invention can be obtained by applying a high-voltage potential to an article while the article is immersed in plasma. The plasma can consist of any hydrocarbon gas or mixture of gasses, such as, for example, methane, ethane, any or all isomers of propane, any or all isomers of butane, ethylene, any or all isomers of propylene, acetylene, propyne, 1-butyne, 2-butyne, similar compounds, and mixtures of any of these. Preferably the plasma includes acetylene.

In the practice of the present invention, a high-voltage potential can be applied to an article immersed in plasma for periods of shorter or longer duration, depending on the thickness of the DLC coating desired. Thicker DLC coatings require longer periods of exposure to plasma, while thinner DLC coatings do not require as long a period of exposure as a potential is applied. Coatings of from about 0.001 to about 5 microns are obtained in the practice of the present invention. Preferably coatings of from about 0.005 to about 4.5 microns are obtained. More preferably coatings of from about 0.010 to about 4.0 microns, and most preferably coatings of from about 0.100 to about 3.5 microns are obtained.

High voltage, as used herein, means a potential of at least about 0.5 kilovolt (kV) wherein 1 kV equals 6.242×10²¹ electron-volts (eV), preferably at least about 1.0 kV, more preferably at least about 1.5 kV, and most preferably at least about 2 kV. In the practice of the present invention, a high voltage potential can be applied to a second article that is in contact with the article to be coated. Preferably, the second article is conductive and is in contact with at least about 30% of the surface area of the article. Preferably, 100% of the surface to be coated is exposed to the plasma.

A DLC coated article of the present invention can be obtained by a process comprising the steps: cleaning the surface of the article to be coated; placing the article in contact with a conductive material; placing the article in a PSII (plasma source ion implantation) chamber; removing air and moisture from the samples by evacuating the chamber; further cleaning the surfaces by sputtering the surface with an inert gas, e.g. argon, plasma; introducing a hydrocarbon vapor to the chamber; and applying an electrical pulse of voltage in the range of less than about 10 kV, preferably less than about 5 kV, more preferably less than about 4 kV, and most preferably less than about 3 kV to the chamber and its contents, to obtain a DLC coated article.

An electrical pulse can be applied to the target object to be coated for a sufficient time to obtain coatings of various thicknesses. The pulse can be applied multiple times in order to obtain the desired coating. For example, coating thicknesses in the range of from about 0.01 to about 5 microns can be obtained by subjecting the article the plasma for up to about 24 hours.

A DLC coating applied according to the process of the present invention implants, or imbeds, particles of carbon below the surface of the substrate being coated. In this manner the composition of the coated article near the surface has a composition that undergoes a gradual transition from pure substrate material to a mixture of substrate material with imbedded carbon particles to pure carbon at the surface of the coated article. One advantage of this technique is that this gradual transition from one composition to another at or near the surface of the coated article results in better adhesion of the DLC coating to the substrate. The better adhesion that is achieved directly between the DLC coating and the substrate as a result of the coating process used herein eliminates either the need for a discrete and distinct adhesive layer to bond the DLC coating to the substrate, or the requirement for a pretreatment of the substrate surface to enhance adhesion of the coating to the substrate surface.

The hardness of an article coated with a DLC coating is increased compared to the hardness of the non-coated article. The penetration depth of an impinging load is decreased for a coated article compared to that of a non-coated article. The coefficient of friction of a DLC coated article of the present invention is decreased compared to that of the non-coated article.

DLC coated articles of the present invention can have good optical properties, such as low haze and high clarity. The optical properties can be dependent on the thickness of the DLC coating on the article. Haze values of DLC coated articles of the present invention can be less than 3.0%, preferably less than 2.5%, more preferably less than 1%, and most preferably less than 0.5%. Clarity of a DLC coated article of the present invention can be greater than 92%, preferably greater than 95%, more preferably greater than 97%, and most preferably greater than 98%.

DLC coated articles of the present invention can be useful as, for example, architectural glazing, sidelights on automobiles, automobile rock shields, guide pins, etc.

In another embodiment, the present invention is a coated plastic article having an initially soft surface prior to application of a hard coating. The soft plastic can be a plastic material such as polyethylene terephthalate (PET), polymethylmethacrylate (PMMA), polycarbonate (PC), or like materials. Plastics suitable for use in the present invention can have a hardness as measured by a Berkowich Indenter and expressed in GPa, of less than about 0.3 to about 0.5.

### EXAMPLES

The following examples are presented to illustrate the invention described herein, but in no way are meant to limit the scope of the present invention.

### Example 1

Two float glass 4×4×0.090 inch panels are thoroughly cleaned, then placed in a horizontal position with one panel having the tin side up (exposed to the atmosphere) and the other panel having the nontin side up. The panels are laid on a water-cooled horizontally placed aluminum plate in a PSII chamber. The aluminum plate is electrically connected to the generator of the pulsed potential power source. The chamber is evacuated via a vacuum pump for an hour to remove air and excess moisture from the samples. After an hour, the samples are sputtered using an plasma created with 10 milli-torr of argon for 10 minutes to clean the surfaces. Acetylene is introduced at a pressure of 5 milli-torr and the plasma is started and run for 4 hours to obtain a uniformly coated DLC coated article. The DLC coating is 1.36 microns in thickness, as determined by use of both a RUDOLPH FTM film thickness measuring instrument and a profilometer. The coating was tested using the pencil hardness test (ASTM D3363-74, reapproved in 1989), and was not scratched by even the hardest lead (6H). The Taber abrasion test is also run (ANSI Z-26.1 Standard No.34), and the DLC has 0% haze increase thereby showing very superior resistance to abrasion.

Two additional tests were run with the PSII apparatus wherein glass samples were subjected to the acetylene plasma for 9 and 17 hours to give DLC coatings measuring 1.8 and 3.2 microns thick, respectively. These samples were evaluated for hardness, Young's Modulus, coefficient of friction, and penetration depth at 20 mN. The results are given in Table 1 below.

TABLE 1

| | HARD- | | | |
|---|---|---|---|---|
| | NESS | YOUNG'S | COEFFICIENT | PENETRATION |
| SAMPLE | (Gpa) | MOD (Gpa) | OF FRICTION | DEPTH AT 20 mN |
| Glass | 8 | 72 | 0.71 | 1,100 nm |
| DLC @ | 15 | 105 | 0.35 | 500 nm |
| 1.8 | | | | |
| microns | | | | |
| DLC @ | 15 | 115 | 0.33 | 450 nm |
| 3.2 | | | | |
| microns | | | | |

Three additional samples of 90 mil glass were coated according to the above procedures, and the Haze was measured according to the ASTM D 1003 method using a model “Haze-gard Plus” Gardner Haze Meter. The same instrument was also used to measure the clarity of each sample. Clarity is a measure of see-through quality and describes how well very fine detail is resolved through the specimen. The results are shown in Table 2.

TABLE 2

| | DLC Coating | | |
|---|---|---|---|
| | Thickness | | |
| Sample | (microns) | Haze (%) | Clarity (%) |
| Control | 0 | 0.2 | 100 |
| DLC1 | 0.2 | 0.2 | 99.8 |
| DLC2 | 1.36 | 0.7 | 98.7 |
| DLC3 | 1.8 | 2.3 | 98.5 |

The DLC coating adds very little haze and has a minimal affect of clarity, thereby showing it to be a viable coating for optically sensitive applications such as glazing.

### Example 2

Polyethyleneterephthalate (PET) clear films, 0.007 inches thick, were flame-treated prior to being coated. The PET films were laid onto a conductive metal plate, located inside of the PSII chamber, the plate being connected to the pulse generator which was used to create the pulsed potential required to attract acetylene plasma moieties onto the exposed PET surfaces. The films were held down at the edges by thin aluminum strips. The metal plate was cooled to—° C. The PET films were treated in three separate runs of varying lengths.

Sample A was treated for 1 hour and a DLC coating of about 0.2 microns was obtained. This coating was very glossy and uniform in appearance with an amber color and low haze, good transparency and excellent see-through clarity.

Samples B and C were coated together for 8 hours in a second run to give approximately a 1.0 micron thick DLC coating that was darker in color but with good see-through clarity and low haze.

Sample C was exposed to about 9 hours additional treatment in order to apply more DLC onto the already present 1.0 micron DLC coating to give a final coating thickness of about 2.0 microns. This thick DLC coating was very dark and glossy with good uniformity of appearance. This sample was opaque.

These samples were measured for coating thickness using a Perthometer profilometer and they were also measured for surface hardness and surface young's modulus using a Berkovich Indenter calibrated with fused silica. Coefficient of friction was measured using a NANO Indenter XP instrument.

An uncoated PET film was used as a control and a polysiloxane Abrasion Resistant Coated (PARC) PET film was tested as well for comparison purposes. The PARC coated sample was a standard commercial grade of abrasion resistant film commonly used in glazing applications. It has excellent scratch and abrasion resistance. Results are given in Table 3 below.

TABLE 3

| | DLC | | Young's | | | Coeff. |
|---|---|---|---|---|---|---|
| | Thickness | Hardness | Modulus | Haze | Clarity | of |
| Sample | Microns | GPa | GPa | % | % | Friction |
| PET | No DLC | 0.5 | 4.45 | 0.6 | 99.9 | 0.9 |
| Film | | | | | | |
| A | 0.2 | 5.4 | 35 | 0.8 | 99.7 | 0.2 |
| B | 1.0 | 10 | 75 | 3.5 | 98.9 | 0.2 |
| C | 2.0 | 20 | 115 | | | 0.2 |
| PARC on | No DLC | 3 | 14 | 0.4 | 100 | 0.1 |
| PET | | | | | | |

The DLC coating has a much lower coefficient of friction and is much harder than the PET film. The DLC also has a much higher stiffness as reflected in the Young's modulus figures. The combination of properties offered by coating with DLC gives a surface that is much more resistant to abrasion and scratching. The PARC falls intermediate in properties between uncoated PET film and the DLC coated films.

The DLC coatings covered the PET film samples very uniformly and this was a surprise in that a non-conductive substrate film could be coated so well by the PSII method.

The DLC coatings are very low in haze and do not affect clarity significantly. DLC coatings can be used in glazing applications based on these optical properties.

### Example 3

The coated films from Example 2 were laminated to glass using standard autoclaving conditions of 30 minutes under pressure at 125-150° C. The coated PET films were bonded to glass using BUTACITE® polyvinyl butyral (PVB) sheeting with the coated sides of the PET films facing away from the PVB sheeting. A sacrificial glass coverplate was used on the coated PET films to give the sandwich an optically flat surface necessary for glazing applications. After autoclaving, the glass cover plate was removed and discarded. The resultant DLC/PET/PVB/GLASS laminate was clear and the DLC coated plastic side was optically flat and suitable for glazing applications. These laminates were tested for abrasion resistance using the Taber Abrader test (ANSI Z-26.1 Standard, Test Number 34) and the degree of abrasion was compared from photomicrographs of the surfaces. They were also tested for coating adhesion before and after immersion in boiling water for 2 hours. The coating adhesion was tested using the standard tape peel adhesion approach (ASTM D 3359-87) utilizing “PERMACEL” tape having a peel strength against steel of 40 ounces/inch. Results are given in Table 4 below.

TABLE 4

| | DLC Thickness | Taber Abraded Surface |
|---|---|---|
| Sample | Microns | Scratching |
| PET Film | No DLC | Extremely heavy |
| | | scratching over 98% of |
| | | surface |
| A | 0.2 | Extremely heavy |
| | | scratching over 95% of |
| | | surface |
| B | 1.0 | very light scratches over |
| | | 1-2% of surface |
| C | 2.0 | Occasional very light |
| | | scratch |
| PARC on PET | No DLC | Moderate scratching with |
| | | occasional tearing of |
| | | PARC |

The DLC coatings exhibit excellent adhesion to the PET film both before and after immersion in boiling water for 2 hours. No blisters formed with any of the coatings with immersion in boiling water.

### Example 4

Three different plastic substrates were coated together using the PSII apparatus and technique already described with a coating time of 1 hour to give a coating of about 0.17 microns. The plastics treated were PET film (the sample “A” in preceding examples), LUCITE® (registered trademark of ICI) polymethylmethacrylate sheeting, and LEXAN® (registered trademark of General Electric) polycarbonate sheeting. All three samples coated uniformly with an amber colored DLC coating that was clear and without haze. The samples were measured for hardness and Young's modulus to determine the affect of the DLC coating on scratch and abrasion resistance. Results are shown in Table 5.

TABLE 5

| | | Hardness | Young's Modulus |
|---|---|---|---|
| Sample | Coating | GPa | GPa |
| PET Film | None | 0.5 | 4.5 |
| A | DLC | 5.4 | 35 |
| Lucite | None | 0.35 | 3.5 |
| Lucite | DLC | 3.75 | 32 |
| Lexan | None | 0.3 | 3.5 |
| Lexan | DLC | 4.0 | 25 |

The 0.2 micron DLC coating on all three plastics significantly increases the hardness and the stiffness of the surfaces.

1. An article comprising a diamond-like carbon (DLC) coating directly on a non-metallic material, wherein the DLC coating is from 0.001 to about 5 microns thick wherein the non-metallic surface is coated in a process comprising the step: applying a high-voltage electrical pulse to the surface while the surface is immersed in a chamber filled with a hydrocarbon plasma and wherein the voltage of the electrical pulse is from about 0.5 to about 10 kV.

2. The article of claim 1 wherein the non-metallic material is glass or plastic.

3. The article of claim 2 wherein the DLC coating is from about 0.005 microns to about 4.5 microns thick.

4. The article of claim 3 wherein the DLC coating is from about 0.010 microns to about 4.0 microns thick.

5. The article of claim 4 wherein the DLC coating is from about 0.050 microns to about 3.5 microns thick.

6. The article of claim 5 wherein the voltage of the electrical pulse is from about 1.0 to about 5 kV.

7. The article of claim 6 wherein the voltage of the electrical pulse is from about 1.5 to about 4 kV.

8. The article of claim 7 wherein the voltage of the electrical pulse is from about 2 to about 3 kV.

9. The article of claim 8 wherein the material is plastic.

10. The article of claim 8 wherein the material is glass.
